(19) United States
(12) Patent Application Publication
(10) Pub. No.: US 2005/0113513 A1
(43) Pub. Date: May 26, 2005

(54) Curable silicone pressure adhesive coating compositions

(76) Inventor: Roy Melvin Grisworld, Ballston Spa, NY (US)

Correspondence Address: Kenneth S. Wheelock;General Electric Company, One Plastics Avenue, Pittsfield, MA, 01201, US

(21) Appl. No.: 10/721,395

(22) Filed: Nov. 25, 2003

(51) Int. Cl. C08L 83/04

(52) U.S. Cl. 524/866; 528/15; 528/32

(57) ABSTRACT

Silicone pressure sensitive adhesive compositions of an addition cured silicone pressure sensitive adhesive composition of (A) an aromatic soluble silicone MQ resin or resinous copolymer having R₃SiO_{1/2 and} SiO_{4/2}; an alkenyl-containing polydiorganosiloxane having a viscosity of at least about 3,000 centipoises at 25° C.; a hydrosilylation agent; (B) a hydrosilylation catalyst; and optionally a hydrosilylation inhibitor, and a solvent.

The present invention relates to curable silicone pressure sensitive adhesive coating compositions. More particularly, the present invention relates to addition curable silicone compositions that cure to form pressure sensitive adhesive compositions having high tack; peel adhesion and high temperature lap shear properties. The present invention also provides cured silicone pressure sensitive adhesive compositions. Furthermore the present invention relates to the process for making a silicone pressure sensitive adhesive coating.

### BACKGROUND OF THE INVENTION

The term “pressure sensitive adhesives” (PSA) as used herein refers to adhesives that can be adhered to a surface and yet can be removed from the surface without transferring more than trace quantities of adhesive to the surface, and can be readhered to the same surface or another surface because the adhesive retains some or all of its tack and adhesive strength. Silicone pressure sensitive adhesives (PSA's) have excellent adhesive and cohesive strength, and high tack as well as excellent heat resistance, cold resistance, electrical properties, and the like, which makes them applicable for use as electrical-insulating tape and for various pressure-sensitive products that must be resistant to hot and cold.

Silicone compositions capable of curing to form pressure sensitive adhesive compositions are known in the art.

U.S. Pat. No. 3,983,298 Hahn et al discloses a PSA composition comprised of (a) a benzene soluble MQ resin with less than 0.5% unsaturation, (b) 20-100,000 cps. vinyl terminated polysiloxane, with (a) and (b) devolatized to give less than 10% solvent, (c) an organohydrogenpolysiloxane, and (d) a platinum catalyst.

U.S. Pat. No. 4,774,297 Murakami et al discloses a PSA composition comprised of (a) a benzene soluble MQ resin with 5 mole % or less unsaturation, (b) equal or great than 500,000 cps. vinyl terminated polysiloxane, (c) an organohydrogenpolysiloxane with at least two hydrogen atoms per molecule, (d) a platinum catalyst, and (e) an organic solvent.

U.S. Pat. No. 4,988,779 Medford et al discloses a composition suitable for forming a PSA comprised of no more than (a) 5-10% solvent, (b) 30 to 50 parts of vinyl-containing polyorganosiloxane fluid having a viscosity of from 500 to 10,000 cps at 25° C., (c) from 50 to 70 parts of a benzene soluble MQ resin, (d) an organopolysiloxanes having silicon bonded hydrogen atoms, (e) and a platinum catalyst.

U.S. Pat. No. 5,169,727 Boardman et al discloses a high solid adhesive composition comprising (a) a benzene soluble MQ resin, (b) diorganoalkenylsiloxy end blocked polydiorganosiloxane, (c) a diorganohydrogensiloxy end-blocked polysiloxane, (d) a crosslinking agent, and (e) a hydrosilylation catalyst.

U.S. Pat. No. 5,576,110 Lin et al discloses a composition comprised of (a) MQ resin, (b) an alkenyl-containing polydiorganosiloxane, (c) a crosslinker comprised of (i) a multifunctional hydrogen-containing organosiloxane, and (ii) a multi-functional alkenyl-containing organosiloxane, (d) a reaction mixture of (a) and (b), (c) a hydrosilylation catalyst, and (f) an organic solvent.

U.S. Pat. No. 5,248,739 Schmidt, et al teaches four separate PSA systems, the addition cured system comprised of (a) an MQ resin with critical molecular weight range of 950-1600 with resin M/Q range of 1.1 to 1.4 (b) an olefinic containing polydiorganosiloxane, (c) an organohydrogenpolysiloxane compatible with (a) and (b), and (d) a platinum catalyst.

The above cited patents requiring a multiplicity of components still results in a need within the industry for an addition curable silicone pressure sensitive adhesive coating composition that provides a balance of adhesion to substrates, increased cohesive strength, good tack, and high temperature lap shear properties. Furthermore, currently commercially available pressure sensitive adhesives fail to provide adhesive compositions with stable adhesive properties upon aging of tapes made from the cited adhesive compositions due the high residual hydrogensiloxy units in cured compositions which post age to non-adhesive coatings.

### SUMMARY OF THE INVENTION

The present invention provides for an addition curable silicone pressure sensitive adhesive coating compositions that contain one or two components and exhibit an excellent balance in adhesion, cohesive, tack and high temperature lap shear properties. The present invention also provides for cured silicone pressure sensitive adhesive compositions. Furthermore, the present invention also provides for addition curable silicone pressure sensitive adhesive compositions that provide stable adhesive properties of tapes made therefrom upon aging. This invention further provides a process for making addition curable silicone PSAs of this invention.

The present invention is directed to one or two component addition curable silicone pressure sensitive adhesive compositions which cure to form PSAs having excellent initial and stable aged adhesion, cohesion, tack and high temperature lap shear properties, comprising either:
(A) the condensation reaction product of from about 50 to about 75 parts by weight of an aromatic soluble resin or resinous copolymer comprising R₃SiO_{1/2} units and SiO_{4/2} units wherein each R is independently a monovalent hydrocarbon radical having from 1 to about 6 carbon atoms, at least 95% of all R groups being an alkyl group, the molar ratio of R₃SiO_{1/2} to SiO_{4/2} being from about 0.6 to about 1.2 inclusive, the resin or resinous copolymer comprises from about 0.2% to about 5.0% by weight, based on the total weight of the resin or resinous copolymer, of hydroxyl radicals; and 25 to about 50 parts by weight of an alkenyl-containing polydiorganosiloxane having a viscosity of at least about 3,000 centipoises at 25° C.; the said condensation reaction product is further reacted with a hydrosilylating agent to render the remaining silanol groups from the condensation reaction with R¹ₐSiX_{4-a/2} wherein R¹ is R or H, and X is N, CL, O, and a is from about 0.5 to 2.0, and a
(B) hydrosilylation catalyst; and optionally a hydrosilylation inhibitor, and 0-70 percent solvent based by weight.
   or:
A single component, addition cured reaction product of (A) and (B) in solvent.

### DETAILED DESCRIPTION OF THE INVENTION

The aromatic-soluble resin or resinous organopolysiloxane copolymer of component (A) imparts peel adhesion and tack to the cured pressure sensitive adhesive prepared from the composition. The resin or resinous copolymer comprises R₃SiO_{1/2} units (also known as “M” units) and SiO_{4/2} units (also known as “Q” units) wherein each R is independently a monovalent hydrocarbon radical having from 1 to about 6 carbon atoms. Examples of radicals represented by R include alkyl radicals such as methyl, ethyl, and isopropyl; cycloaliphatic radicals such as cyclopentyl and cyclohexanyl; olefinic radicals, such as vinyl and allyl; and phenyl radical. At least 95% by weight of all R groups are akyl groups, preferably methyl. The molar ratio of R₃SiO_{1/2} units to SiO_{4/2} units being from about 0.6 to about 1.2 inclusive. The resin or resinous copolymer comprises from about 0.2% to about 5% and preferably from about 1.0% to about 3.0% and most preferably from about 1.5% to about 2.5%, by weight based on the total weight of the resin or resinous copolymer, of hydroxyl radicals. The hydroxyl radicals are bonded directly to the silicon atom of the SiO_{4/2} units.

The resin or resinous copolymer of component (A) of this invention is in the amount of within the range of 50 to about 75 parts by weight, preferably from about 50 to about 70, and most preferably from about 50 to about 62 parts by weight.

Methods for making the resin or resinous copolymer of component (A) are known in the art. Reference is made, for example to U.S. Pat. No. 2,676,182 to Daubt, et al, which is hereby incorporated by reference. In the Daubt et al method, a silica hydrosol is reacted under acidic conditions with a source of triorganosiloxy units such as hexaorganodisiloxane, e.g., hexamethyldisiloxane, or a hydrolysable triorganosilane, e.g., trimethylchlorosilane, or mixtures thereof, and recovering a benzene soluble resin copolymer having M and Q units.

The alkenyl-containing polydiorganosiloxane of component (A) is at least about 3,000 centipoises, and preferably at least 10,000 centipoises at 25° C. The alkenyl-containing polydiorganosiloxane of the present invention is preferably a polydiorganosiloxane of the following general formula
R¹₂R²SiO(R¹₂SiO)ₓ(R¹₂R³SiO)_{y}SiR²R¹₂ (1)
Wherein each R¹ is independently an alkyl group having from 1 to about 10 carbon atoms such as methyl, ethyl, and propyl; a cycloaliphatic group such as cyclohexanyl or an aryl group such as phenyl; R² is a hydroxyl or an alkenyl group having from 1 to about 10 carbon atoms including α-alkenyls such as vinyl, allyl, propenyl, butenyl, pentenyl, hexenyl or the like; R³ is either R¹ or an alkenyl group having from 1 to about 10 carbon atoms including α-alkenyls such as vinyl, allyl, propenyl, butenyl, pentenyl, hexenyl or the like. The sum of x and y is at least about 520 to give a viscosity of about 3,000 cps. at 25° C. Preferably the alkenyl-containing is an alkenyl-containing polydimethylsiloxane, alkenyl-containing poly(dimethyl-co-dimethylphenyl)siloxane, alkenyl-containing poly(dimethyl-co-diphenyl)siloxane. Preferably the alkenyl group is vinyl.

Alkenyl-containing polydiorganopolysiloxanes can be prepared by any conventional methods for preparing hydroxyl or triorganosiloxy-terminated polydiorganosiloxanes. For example, a proper ratio of the appropriate hydrolysable silanes, e.g, vinyldimethylchlorosilane and dimethyldichlorosilane, may be co-hydrolyzed and condensed or alternatively an appropriate 1,3-divinyltetraorganodisiloxane, e.g., symmetrical divinyldimethyldiphenylsiloxane or divinyltetramethyldisiloxane, which furnishes the endgroups of the polydiorganosiloxane, may be equilibrated with an appropriate diorganopolysiloxane, e.g., octamethylcyclotetrasiloxane, in the presence of an acidic or basic catalyst. Regardless of the method of preparation of the polydiorganosiloxane, there is usually coproduced a varying quantity of volatile, cyclic polydiorganosiloxanes. Volatile cyclic polydiorganopolysiloxanes, e.g., methyl tetramer, should be removed since they are volatile and adversely affect pressure sensitive adhesive properties as well as collecting as a fine white dust in tape manufacturer's drying/curing ovens decreasing oven efficiency. Preferably the polydiorganosiloxanes are essentially free of cyclic material with the exception of trace quantities of macrocyclic polydiorganosiloxanes which are non-volatile at 150° C. and atmospheric pressure. Furthermore, the polydiorganosiloxanes can be homopolymers or copolymers or their several mixtures of formula (I).

The polymer chain of the preferred form of polydiorganosiloxane, exclusive of terminal units, is made up of diorganopolysiloxane units containing R¹ and R³ radicals can be identical or a mixture of R¹ and R³ radicals. Trace units of R¹₃SiO_{1/2} units, R¹SiO_{3/2} units and SiO_{4/2} units are permissible.

The value of the sum of x and y is such that the viscosity of the polydiorganosiloxane is at least 3,000 cps. at 25° C. Depending on the type of R¹ radicals in the polydiorganosiloxane, the permissible average value of the sum of x and y is at least 520.

The amount of polydiorganosiloxane of component (A) of this invention is in the amount of within the range of 25 to about 50 parts by weight, preferably from about 30 to about 50, and most preferably from about 38 to about 50 parts by weight.

The said reaction product of the resin or resinous copolymer and polydiorganosiloxane of (A) then followed by termination of remaining silanol groups with R¹ₐSiX_{4-a/2} wherein R¹ is R or H, and X is N, CL, O, and a is from about 0.5 to 2.0, are preferably silazanes, disilazanes, polysilazanes, and siloxanes which react with silanol groups to yield silicon-hydride functionality. Examples of silazanes, disilazanes and polysilazanes include 1,2,3,4,5,6-hexamethylcyclotrisilazane, 1,1,3,3-tetramethyldisilazane, KiON® Corporation S, KiON® Corporation VL20, KiON® Corporation ML33/C33, KiON® Corporation CERASET, (N,N)-dimethylamino)dimethylsilane, ethyldichlorosilane, dimethylethoxysilane, dimethylaminomethylethoxysilane, dimethylchlorosilane, diphenylchlorosilane, ethylbis(trimethylsiloxy)silane, hexyldichlorosilane, methyldichlorosilane, phenyldichlorosilane, phenyldiethoxysilane, phenylmethylchlorosilane, 1,3,5,7-tetraethyl-2,4,6,8-tetramethylcyclotetrasilazane, 1,1,3,3-tetramethyldisiloxane, 1,2,3-triethyl-2,4,6-trimethylcyclotrisilazane.

A single component reaction product of component (A) and (B) is incorporated into the present invention as an alternative for two components (A) and (B) being used in a coating process.

Typical platinum-containing catalyst of component (B) in the polydiorganosiloxane compositions of this invention is any form of chloroplatinic acid, such as, for example, the readily available hexahydrate form or the anhydrous form, because of its easy dispensability in organosiloxane systems. A particularly useful form of chloroplatinic acid is that composition obtained when it is reacted with an aliphatically unsaturated organosilicon compound such as divinyltetramethyldisiloxane, as disclosed by U.S. Pat. No. 3,419,593 incorporated herein by reference.

The amount of catalyst component that is used in the compositions of this invention is not narrowly limited as long as there is a sufficient amount to accelerate a room temperature reaction between the silicon-bonded hydrogen atoms of Component (A) with the silicon-bonded olefinic hydrocarbon radicals of Component (A). The exact necessary amount of said catalyst component will depend upon the particular catalyst and is not easily predictable. However, the said amount can be as low as one part by weight of platinum for every one million parts by weight of organosilicon Component (A).

For compositions (A) of this invention which are to be used in the coating method of this invention, the amount of platinum-containing catalyst component to be used is preferably sufficient to provide from 5 to 500 parts by weight platinum per one million parts by weight of polydiorganosiloxane component (A).

The hydrosilylation catalyst is selected from the group consisting of catalysts comprising a metal selected from the group consisting of nickel, palladium, platinum, rhodium, iridium, ruthenium and osmium or as taught in U.S. Pat. Nos. 3,159,601; 3,159,662; 3,419,593; 3,715,334; 3,775,452 and 3,814,730.

Optional uses of inhibitors for the platinum group metal catalysts are well known in the organosilicon art. Examples of various classes of such metal catalyst inhibitors include unsaturated organic compounds such as ethylenically or aromatically unsaturated amides, U.S. Pat. No. 4,337,332; acetylenic compounds, U.S. Pat. Nos. 3,445,420; 4,347,346 and 5,506,289; ethylenically unsaturated isocyanates, U.S. Pat. No. 3,882,083; olefinic siloxanes, U.S. Pat. No. 3,989,667; unsaturated hydrocarbon diesters, U.S. Pat. Nos. 4,256,870; 4,476,166 and 4,562,096, and conjugated ene-ynes. U.S. Pat. Nos. 4,465,818 and 4,472,563; other organic compounds such as hydroperoxides, U.S. Pat. No. 4,061,609; ketones, U.S. Pat. No. 3,418,731; sulfoxides, amines, phosphines, phosphites, nitriles, U.S. Pat. No. 3,344,111; diaziridines, U.S. Pat. No. 4,043,977; half esters and half amides, U.S. Pat. No. 4,533,575; and various salts, such as U.S. Pat. No. 3,461,185. It is believed that the compositions of this invention can comprise an inhibitor from any of these classes of inhibitors.

The inhibitors may be selected from the group consisting of ethylenically unsaturated amides, aromatically unsaturated amides, acetylenic compounds, ethylenically unsaturated isocyanates, olefinic siloxanes, unsaturated hydrocarbon diesters, unsaturated hydrocarbon mono-esters of unsaturated acids, conjugated ene-ynes, hydroperoxides, ketones, sulfoxides, amines, phosphines, phosphites, nitriles, and diaziridines.

Preferred inhibitors for the compositions of this invention are the maleates and alkynyl alcohols.

The amount of optional inhibitor that may be used in the compositions of this invention is not critical and can be any amount that will retard the above-described platinum-catalyzed hydrosilylation reaction at room temperature while not preventing said reaction at moderately elevated temperature, i.e. a temperature that is 25 to 50° C. above room temperature. No specific amount of inhibitor can be suggested to obtain a specified bath life at room temperature since the desired amount of any particular inhibitor to be used will depend upon the concentration and type of the platinum group metal-containing catalyst, the nature and amounts of Components (A) and (B). The range of inhibitor can be 0.1-10% by weight, preferably 0.15-2% by weight, and most preferably 0.2-1% by weight.

The compositions of the present invention may be used either as formulations that are free of solvent, i.e. 100% solids, diluted with an organic solvent that is miscible, or as an aqueous emulsion. Examples of volatile organic solvents include volatile liquid hydrocarbon solvents such as volatile non-aromatic hydrocarbons, e.g. pentane, the iso-pentanes, cyclopentane, hexane, the iso-hexanes, cyclohexane, heptane, the iso-heptanes, cycloheptane, octane, the iso-octanes, cyclo-octane, 1-hexadecene, 1-octadecene, 1-eicosene, 1-tetradecene, 1-docsene and the like; volatile aromatic solvents such as benzene, toluene, the various xylenes, mesitylene and the like are examples of suitable hydrocarbon solvents that may be used. It is also possible to utilize low molecular weight oxygen containing solvents such as alcohols, ketones, aldehydes and the like. Additional non-reactive volatile solvents that may be employed may be selected from the group consisting of:
(1) cyclic diorganosiloxanes having the formula (VI):
   (R¹⁰₂SiO)ₚ, (VI)
   wherein R¹⁰ is a monovalent hydrocarbon radical having from one to ten carbon atoms, preferably one to eight, more preferably one to six, and most preferably one to four carbon atoms; and p is an integer having values ranging from three to eight and
linear volatile silicones having the formula (VII):
   (R¹¹₃SiO_{1/2})(R¹²₂SiO_{2/2})_{q}(R¹³₃SiO_{1/2}) (VII)
   wherein each R¹¹, R¹² and R¹³ is independently a monovalent hydrocarbon radical having from one to ten carbon atoms, preferably one to eight, more preferably one to six, and most preferably one to four carbon atoms and q is an integer of from 0 to 8. When the formulation of the present invention is used as a solventless coating, it is preferred that the viscosity of the alkenyl silicone be in a range varying from about 5,000 to about 200,000 centipoise, preferably from about 5,000 to about 100,000, most preferably from about 5,000 to about 60,000 centipoise. This is most easily accomplished by manipulation of the ratios of the stoichiometric subscripts of the polydiorganosiloxane component of composition (A); the ratio of resin or resinous and the polydiorganosiloxane components of composition (A).

When used as emulsions, the silicones of the present invention are generally emulsified by the addition of non-ionic surfactants, addition of water followed by processing in a colloid mill.

All United States patents referenced herein are herewith and hereby specifically incorporated by reference.

### EXPERIMENTAL

The following examples are designed to illustrate the present invention and are not to be construed as limiting the invention as embodied in these specific examples.

Test Method:

All tack measurements were using both 100 g/cm² and 1000 g/cm² applied pressures on a Polyken® Probe Tack instrument with 1.0 second dwell time and 1.0 cm/s pull speed. Peel adhesion was measured by applying a 1 inch×6 inch tape to a clean stainless steel panel (ASTM A167) panels, a 4.5 pound rubber roller passed over the tape in both directions then peeled at 180 degree from the panel at 12 inches/minute after a 20 minute dwell time. The high temperature lap shear strength was tested by applying a 1′×1″ area of adhesive coated tape to a stainless steel panel. A 500 g weight was affixed to the adhesive strip then placed into a 500° F. forced air oven. This was monitored for slippage up to 24 hrs. If no slippage occurred after 24 hours it was recorded as a pass, if slippage occurred without total failure the slippage in inches were recorded. The lap shear hold time in the oven was recorded along with slippage if it occurred. Testing was terminated at 24 hours and recorded as ≧24 hours. Unless noted all results were using a 1 mil polyimide film for adhesive coating.

### Example 1

To a 1 liter reactor was charged the following components: 0.04 g of a 10 wt % aqueous solution of NaOH, 281.3 g of a 10.6 cstks. 60% toluene solution viscosity MQ resin, 125.0 g of a 791 ppm vinyl content 297800 poise viscosity vinyl functional polydimethylsiloxane, and 80.0 g toluene. This mixture was refluxed for two hours then cooled followed by addition of 0.06 g of a 10 wt % solution of phosphoric acid. After agitation for 1 hour, 5.0 g of tetramethyldisilazane was agitated for an additional 13 hours then heated to reflux removing 38.8 g volatiles. Solids were adjusted to 61.0 wt % and the adhesive viscosity was 37,000 cps. at 25° C. To this reaction mixture was added 0.5 wt % based on adhesive solids of dimethylmaleate inhibitor. The above was catalyzed with platinum (89023) at 50 ppm platinum then coated and cured as described above for 5 minutes at 150° C. The Polyken® Probe Tack results were 460 g/cm² and 592 g/cm² for the 100 g/cm² and 1000 g/cm² applied pressures respectively. Peel adhesion was 18 oz/inch. Lap shear passed after ≧24 hours. This formulated bath was recoated, cured and tested after four days at room temperature. The Polyken® Probe Tack results were 747 g/cm² and 963 g/cm² for the 100 g/cm² and 1000 g/cm² applied pressures respectively, with peel adhesion of 25 oz/inch. Lap shear passed after ≧24 hours. This coated polyimide film was retained at room temperature for nine months then retested for peel adhesion and tack. Peel adhesion was 28 oz/inch and tack results were 975 g/cm² and 772 g/cm² for above pressures respectively.

### Example 2

To a 1 liter reactor was charged the following components: 0.04 g of a 10 wt % aqueous solution of NaOH, 255.0 g of a 6.0 cstks. 60% toluene solution viscosity MQ resin, 101.9 g of a 791 ppm vinyl content 297800 poise viscosity vinyl functional polydimethylsiloxane, 5.9 g tetraethylorthosilicate, and 85.0 g toluene. The mixture was heated at approximately 70° C. for 4 hours followed by addition of 2.7 g water. After agitation for 1 hour the mixture was refluxed for two hours then cooled followed by addition of 0.06 g of a 10 wt % solution of phosphoric acid. Solids were adjusted to 61.0 wt % and the adhesive viscosity was 30,200 cps. at 25° C. The mixture was divided into three portions and different amounts of tetramethyldisilazane added to each which were then agitated thoroughly. To each was added 25 ppm platinum as Karstedt catalyst then coated and cured on 1 mil polyimide film for 5 minutes at 150° C. Table 1 below summarizes the tack, peel adhesion and lap shear properties.

TABLE 1

| | | | Peel | |
|---|---|---|---|---|
| % | Tack, | Tack, | Adhesion, | Lap Shear, |
| Tetramethyldisilazane | 100 g/cm² | 1000 g/cm² | oz./in. | hrs. |
| 1.0 | 937 g/cm² | 964 g/cm² | 25.5 | ≧24 hrs. |
| 2.0 | 942 g/cm² | 1000 g/cm² | 25.5 | ≧24 hrs. |
| 3.0 | 975 g/cm² | 986 g/cm² | 26.0 | ≧24 hrs. |

### Example 3

To a 3 liter reactor was charged the following components: 0.47 g of a 10 wt % aqueous solution of LiOH, 985.3 g of a 6.0 cstks. 60% toluene solution viscosity MQ resin, 393.7 g of a 310 ppm vinyl content 297800 poise viscosity vinyl functional polydimethylsiloxane, 24.2 g tetraethylorthosilicate, and 285.5 g toluene. The mixture was heated at approximately 70° C. for 4 hours followed by addition of 10.4 g water. After agitation for 1 hour the mixture was refluxed for two hours then cooled followed by addition of 0.4 g of a 10 wt % solution of phosphoric acid. Solids were adjusted to 60.0 wt % and the adhesive viscosity was 22,600 cps. at 25° C. Two hundred fifty grams of mixture was agitated with 4.5 g tetramethyldisilazane and a nitrogen purge to remove ammonia at 60° C. for 24 hours. A 25.0 g sample was removed and 50 ppm platinum as in Example 2 was added along with 200 ppm 2-methyl-3-butyn-2-ol, and 12.0 g toluene. This was coated and cured as per Example 2. Properties were: 450 g/cm² for Tack, 100 g/cm²; 876 g/cm² for Tack, 1000 g/cm²; 34.2 oz/in peel adhesion, and ≧24 hours for lap shear time.

### Example 4

To a 1 liter reactor was charged the following components: 0.03 g of a 10 wt % aqueous solution of NaOH, 269.0 g of a 10.4 cstks. 60% toluene solution viscosity MQ resin, 80.9 g of a 310 ppm vinyl content 297800 poise viscosity vinyl functional polydimethylsiloxane, and 60.0 g toluene. The mixture was refluxed at approximately 110° C. for 2 hours, cooled and 0.05 g of a 10 wt % solution of phosphoric acid added. To this mixture was added 3.0 g of tetramethyldisilazane diluted in 20.0 g toluene with agitation for 4 hours using a nitrogen sweep to remove ammonia. Initial ppm SiH determined to be 121 ppm on a 100% solids basis. A 0.5 g solution in toluene of 1.0% platinum as Karstedt catalyst was diluted in 150.0 g toluene and added to the reaction mixture at room temperature for 1 hour. The mixture was then heated at reflux for 6 hours. The ppm SiH on 100% solids basis was found to be 77 ppm. The solids were determined to be 40%, and viscosity 3480 cps. This mixture was coated as per Example 2 then tested for adhesive properties.

Properties were: <50 g/cm² for Tack, 100 g/cm²; 206 g/cm² for Tack, 1000 g/cm²; 54 oz/in peel adhesion, and ≧24 hours for lap shear time.

### Example 5

To a 1 liter reactor was charged the following components: 0.03 g of a 10 wt % aqueous solution of NaOH, 172.5 g of a 10.4 cstks. 60% toluene solution viscosity MQ resin, 90.0 g of a 240 ppm vinyl content 300 mm penetration 5.5 mole % phenyl polydimethyldiphenylsiloxane, and 160.0 g toluene. The mixture was refluxed at approximately 110° C. for 2 hours, cooled to room temperature and 0.05 g of a 10 wt % solution of phosphoric acid added. To this mixture was added 1.0 g of tetramethyldisilazane diluted in 50.0 g toluene with agitation for 1-2 hours at room temperature. Mixture was then heated at approximately 70-80° C. for 4 hours using a nitrogen sweep to remove ammonia. Initial ppm SiH determined to be 55 ppm on a 100% solids basis. A 0.3 g solution in toluene of 1.0% platinum as Karstedt catalyst was diluted in 10.0 g toluene and added to the reaction mixture at room temperature for 1 hour. The mixture was then heated at reflux for 2 hours. The ppm SiH on 100% solids basis was found to be 20 ppm. The solids were determined to be 30%, and viscosity 5800 cps. This mixture was coated as per Example 2 then tested for adhesive properties. Properties were: 994 g/cm² for Tack, 1000 g/cm²; 31 oz/in peel adhesion, and ≧24 hours for lap shear time.

### Example 6

To a 1 liter reactor was charged the following components: 0.04 g of a 10 wt % aqueous solution of NaOH, 333.0 g of a 9.9 cstks. 60% toluene solution viscosity MQ resin, 150.0 g of a 0.09 wt % vinyl content 44,250 centipoise vinyl functional polydimethylsiloxane. The mixture was refluxed at approximately 110° C. for 2 hours, cooled to room temperature and 0.05 g of a 10 wt % solution of phosphoric acid added. To this mixture was added 3.0 g of tetramethyldisilazane diluted in 150.0 g toluene with agitation for 1-2 hours at room temperature. Mixture was then heated at approximately 70-80° C. for 4 hours using a nitrogen sweep to remove ammonia. Initial ppm SiH determined to be 166 ppm on a 100% solids basis. The solids were determined to be 90.0%, and viscosity 8,800 cps. A 25.0 g sample of the composition was mixed with 0.25 g 2-methyl-3-butyn-2-ol, 25.0 g toluene and 0.1 g of a 1% platinum solution. This mixture was coated as per Example 2 then tested for adhesive properties. Properties were: 564 g/cm² for Tack, 1000 g/cm²; 49 oz/in peel adhesion, and ≧24 hours for lap shear time.

1. A curable composition comprising
(A) the condensation reaction product of an aromatic soluble silicone resin or resinous copolymer with an alkenyl-containing polydiorganosiloxane, the said condensation reaction product is further reacted with a hydrolsilylating agent to render the remaining silanol groups from the condensation reaction with hydrosilylation groups and a
(B) a hydrosilylation catalyst.

2. The composition of claim 1 additionally comprising a hydrosilylation inhibitor.

3. The composition of claim 1 wherein slightly more than 0 to 90 percent organic solvents selected from the group consisting of aromatic and non-aromatic solvents, cyclic diorganosiloxanes and linear volatile silicones (added to specification) is incorporated.

4. The composition of claim 1 wherein the resin or resinous copolymer ranges from about 50 to about 75 parts by weight and the alkenyl-containing polydiorganosiloxane ranges from about 25 parts to about 50 parts.

5. The composition of claim 1 wherein (putting this word in a claim renders it legally indefinite under section 112) the resin or resinous copolymer ranges from about 50 to about 70 parts by weight and the alkenyl-containing polydiorganosiloxane ranges from about 30 parts to about 50 parts.

6. The composition of claim 1 wherein (112 again) the resin or resinous copolymer ranges from about 50 to about 62 parts by weight and the alkenyl-containing polydiorganosiloxane ranges from about 38 parts to about 50 parts.

7. The composition of claim 1 wherein the resin or resinous copolymer is comprised of R₃SiO_{1/2} units and SiO_{4/2} units wherein each R is independently a monovalent hydrocarbon radical having from 1 to about 6 carbon atoms, subject to the limitation that at least 95% of all R groups are alkyl.

8. The composition of claim 7 wherein the resin or resinous copolymer comprises a molar ratio of R₃SiO_{1/2} to SiO_{4/2} of from about 0.6 to about 1.2 inclusive.

9. The composition of claim 8 wherein the resin or resinous copolymer comprises from about 0.2% to about 5.0% by weight, based on the total weight of the copolymer, hydroxyl radicals.

10. The composition of claim 8 wherein the resin or resinous copolymer preferably comprises from about 1.0% to about 3.0% by weight, based on the total weight of the copolymer, hydroxyl radicals.

11. The composition of claim 8 wherein the resin or resinous copolymer most preferably comprises from about 1.5% to about 2.5% by weight, based on the total weight of the copolymer, hydroxyl radicals.

12. The composition of claim 1 wherein the alkenyl-containing polydiorganosiloxane of the present invention is a polydiorganosiloxane of the following formula:
R¹₂R²SiO(R¹₂SiO)ₓ(R¹₂R³SiO)_{y}SiR²R¹₂
wherein each R¹ is independently an alkyl group having from 1 to about 10 carbon atoms such as methyl, ethyl, and propyl; a cycloaliphatic group such as cyclohexanyl or an aryl group such as phenyl; R² is a hydroxyl or an alkenyl group having from 1 to about 10 carbon atoms including α-alkenyls such as vinyl, allyl, propenyl, butenyl, pentenyl, hexenyl or the like; R³ is either R¹ or an alkenyl group having from 1 to about 10 carbon.

13. The composition of claim 12 wherein the alkenyl-containing polydiorganosiloxane of component (A) is at least about 3,000 centipoises at 25° C.

14. The composition of claim 12 wherein the alkenyl-containing polydiorganosiloxane of component (A) is at least about 10,000 centipoises at 25° C.

15. The composition of claim 1 wherein the said condensation reaction product of the aromatic soluble resin or resinous copolymer and an alkenyl-containing polydiorganosiloxane is further reacted with a hydrolsilylating agent to render the silanol groups remaining from the condensation reaction with R¹ₐSiX_{4-a/2} wherein R¹ is R or H, and X is N, CL, O, and a is from about 0.5 to 2.0.

16. The composition of claim 15 wherein silanol termination to yield a silicon-hydride functionality is preferably selected from silazanes, disilazanes, polysilazanes, and siloxanes (do you mean here that conversion reagents to produce the hydride are to be selected from the group consisting of? Yes).

17. The composition of claim 15 wherein slightly more than 0 to 90 percent is organic solvents selected from the group consisting of aromatic and non-aromatic solvents, cyclic diorganosiloxanes and linear volatile silicones is incorporated. See edits to claim 3

18. The composition of claim 17 further comprising a hydrosilylation inhibitor.

19. The composition of claim 18 wherein the amount of hydrosilylation inhibitor ranges from about 0.1% to about −10% by weight.

20. The composition of claim 18 wherein hydrosilylation inhibitor range is 0.15-2% by weight.

21. The composition of claim 18 wherein hydrosilylation inhibitor range can be 0.2-1% by weight.

22. The composition of claim 18 wherein hydrosilylation inhibitors are selected from the group consisting of maleates and alkynyl alcohols.

23. The composition of claim 1 wherein the hydrosilylation catalyst is selected from the group consisting of nickel, palladium, platinum, rhodium, iridium, ruthenium and osmium.

24. The composition of claim 23 wherein the hydrosilylation catalyst arranges from about 5 to about ppm based on total composition are incorporated (in what?).

25. The composition of claim 1 having a coating viscosity ranging from about 5,000 to about 200,000 centipoise.

26. The composition of claim 1 wherein the coating viscosity ranges is preferably from about 5,000 to about 100,000 centipoise.

27. The composition of claim 1 wherein is the coating viscosity range is most preferably from about 5,000 to about 60,000 centipoise.

28. The composition of claim 1 further comprising water as an emulsion.

29. The composition of claim 15 further comprising water as an emulsion.

30. The composition of claim 1 that is the reaction product of (A) and (B).

31. The composition of claim 30 wherein the organic solvent ranges from about 30 to about 70 percent based on total solids.

32. The composition of claim 31 further comprising water as an emulsion.
